(19) United States
(12) Patent Application Publication
(10) Pub. No.: US 2006/0257232 A1
(43) Pub. Date: Nov. 16, 2006

(54) SYSTEM AND METHOD FOR BOOK DUALBIND PRODUCTION

(75) Inventors: William A. Sullivan, Penfield, NY (US); John M. Lacagnina SR., Webster, NY (US)

Correspondence Address: BASCH & NICKERSON LLP, 1777 PENFIELD ROAD, PENFIELD, NY, 14526, US

(73) Assignee: COLORCENTRIC, CORP., Rochester, NY (US)

(21) Appl. No.: 11/382,765

(22) Filed: May 11, 2006

Related U.S. Application Data
(60) Provisional application No. 60/680,981, filed on May 13, 2005.

(51) Int. Cl. B42C 9/00

(52) U.S. Cl. 412/6

(57) ABSTRACT

A system and method for production of books from a digital source, wherein the books are produced from a plurality of sets of bound color or black/white sheets or pages.

This invention relates generally to the production of books, and more particularly to the production of books from a digital source, wherein the books are produced from a plurality of sets of bound color and black/white sheets or pages.

### BACKGROUND AND SUMMARY

The disclosure found herein is directed to a system and method for the production of books printed on digital image printing systems. With the availability of high-speed, high-quality digital printing there exists a need to produce hardcover or soft cover books in very short run lengths, including a single personalized book. At the same time a number of potential markets exist for producing large numbers of these individual books where cost, time and quality are critical factors. The present disclosure suggests a system and method that can achieve major improvements in the quality and durability of the book, as well as a reduction in the cost and time to produce a hard or soft cover book.

Two of the most difficult elements in binding a book are to guarantee the permanent binding of the sheets and the ease of reading the book i.e., the degree to which the book opens easily and lies flat. In particular it is difficult to achieve permanent binding with thick-coated papers stocks, often used for producing color books, because the digital printing process often deposits a thin layer of release oil or similar materials on the sheets. In addition to the release oil, coated papers present a difficult binding surface to the typical adhesive binding system as there is little surface structure for the adhesive to adhere to. Secondly conventional digital adhesive binding techniques produce relatively stiff bindings which make opening and using books produced with coated or on coated paper difficult to use. Many digital to book printing applications particularly for reference works, text books, training manuals, etc. have a major requirement for ease of use or lay flat characteristics.

As previously noted, such publications are typically printed on a smooth, coated-paper stock because the digital printing process often deposits a thin layer of release oil or similar materials on the sheet. In addition to the release oil, coated paper presents a difficult binding surface to the typical cold or hot adhesive glue system as there is little surface structure for the adhesives to adhere to. As disclosed herein a number of techniques have been developed to remedy these situations. Aspects of the system and method include sewing the sheets, as sets, mechanically to improve strength and interrupting the edge of the sheets (e.g., roughening or notching the sheets) to improve the adhesion of the binding glue.

Once a set of sheets have been fastened together, possibly with added end sheets, a finishing process (e.g., hard cover or soft cover binding process) is required. In case binding finishing, the process adheres the end sheets of the set to the front and back panels of a prepared hardcover book case completing the binding in a hardcover form. In high-volume production this finishing process is done using an adhesive. For short run binding a pressure sensitive adhesive can be applied to the front and back of the inside of the bookcase and the adhesive liner removed to secure the end sheets to the case. It is, however, expensive to add the adhesive and liner to the front and back of the case. Accordingly, another aspect of the system and method disclosed contemplates the manner in which the book blocks may be formed with pre-applied adhesive sheets on the outermost pages to facilitate binding to a hardcover case.

Heretofore, other patents and publications have disclosed stapling/stitching of a set of sheets to form a book block and are hereby incorporated by reference in their entirety, the relevant portions of which may be briefly summarized as follows:

U.S. Pat. No. 5,678,813 to Osako et al. discloses a book binding method for saddle stitching a set of sheets.

Product brochures from Watkiss and Plockmatic also disclose booklet-making systems that are able to produce square-backed booklets.

Disclosed in an embodiment herein is a system and method for creating a bound book, comprising: arranging a plurality of page images for printing; printing the page images on a plurality of substrate sheets, and arranging said sheets into a plurality of sets of sheets; binding said sets of sheets with at least one saddle stitch additionally processing the stapled subsignature to produce a square-backed bound set; interrupting at least a portion of the square-backed edge of the bound sets; and assembling bound sets using an adhesive applied to at least a portion of the square-backed edges thereof to produce a bound book.

Also disclosed herein is a method of creating a bound book from a plurality of sheets, comprising: binding at least two sets of sheets from the plurality of sheets, each set being bound with at least one saddle stitch to produce a square-backed bound set; and assembling the at least two square-backed bound sets using an adhesive applied to at least a portion of the square-backed edges thereof to produce a bound book.

Further disclosed herein is a method for producing a book, comprising: printing a plurality of signature pages in at least one set of pages, wherein at least one of the outermost page faces of said set includes an adhesive surface thereon; and exposing said face with adhesive thereon to an interior face of a hard cover block so as to affix the set of pages to the hard cover block.

### BRIEF DESCRIPTION OF THE DRAWINGS

FIG. 1 is an illustrative example of a process applied in accordance with one aspect of the invention;

FIG. 2 illustrates an exemplary system and various alternative work-flow processes; and

FIGS. 3, 4A, 4B and 5 illustrate various alternatives for processing the signature set edges for binding.

### DETAILED DESCRIPTION

Automatic signature booklet makers have been on the market for many years. Multiple, 4-up sheets are combined, stapled in the center and then folded as described in U.S. Pat. No. 5,678,813. The trimming operation completes the signature booklet. A recent innovation is the square-back signature maker as manufactured by Watkiss and Plockmatic. The square-back devices, in addition to saddle stitching (back or front) with one or more staples, compress the spine of the stapled booklet into a square edge section insuring that the booklet lays flat and opens in a more pleasing manner. The compression step breaks the paper fillers in the spine area reducing the stiffness of the bound book. First, the front and back sheets (or cover) can be used as end sheets and bound into a hard cover case with pre-applied pressure sensitive adhesive present in the inner surfaces of the case.

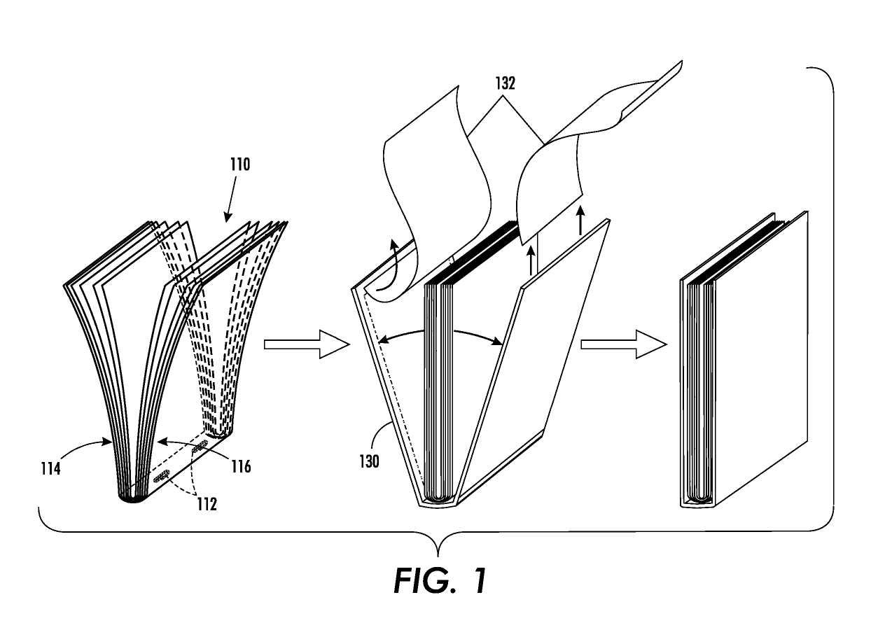

Alternatively, as depicted in FIG. 1, a signature booklet making process is used to prepare a set or book block 110 that is saddle stitched (e.g., staple 112), where the outermost sheet or cover is a sheet containing a pressure sensitive adhesive on the outside thereof (114, 116) with a removable liner. After stapling, folding and converting to a square back the book block can be inserted into a case bound book cover 130 by peeling or removing an adhesive liner 132 on faces 114 and 116, and then wrapping the pre-made cover (e.g., hardcover case 130) around the sets of trimmed booklets 110. In the hardcover example, the resulting hardcover book is securely fastened to the cover 130 so the sheets cannot be removed, and is easy to open and lays flat. It will be further appreciated that the signature bookmaking operation disclosed above may be performed offline or directly in-line with the digital color printing system to improve throughput. It will also be appreciated that the stapling of the signature sets may be back saddle stitched or forward saddle stitched (staple folded inside crease of pages or staple folded on spine, respectively), and that the staple orientation itself may provide advantages relative to the binding of the signature sets and the assembled book.

An extension of this single-signature binding system is a system and method to attach multiple signatures together producing a larger or more conventional book (i.e., more pages than possible with a single saddle-stitched booklet). Single stapled square back signatures produced on high-quality color or black/white printing systems are limited to less than 15 to 25 sheets, producing 60 to 100 pages. Multiple stapled, square-back signatures can be bound, in accordance with the present system and method, into a single book using several methods.

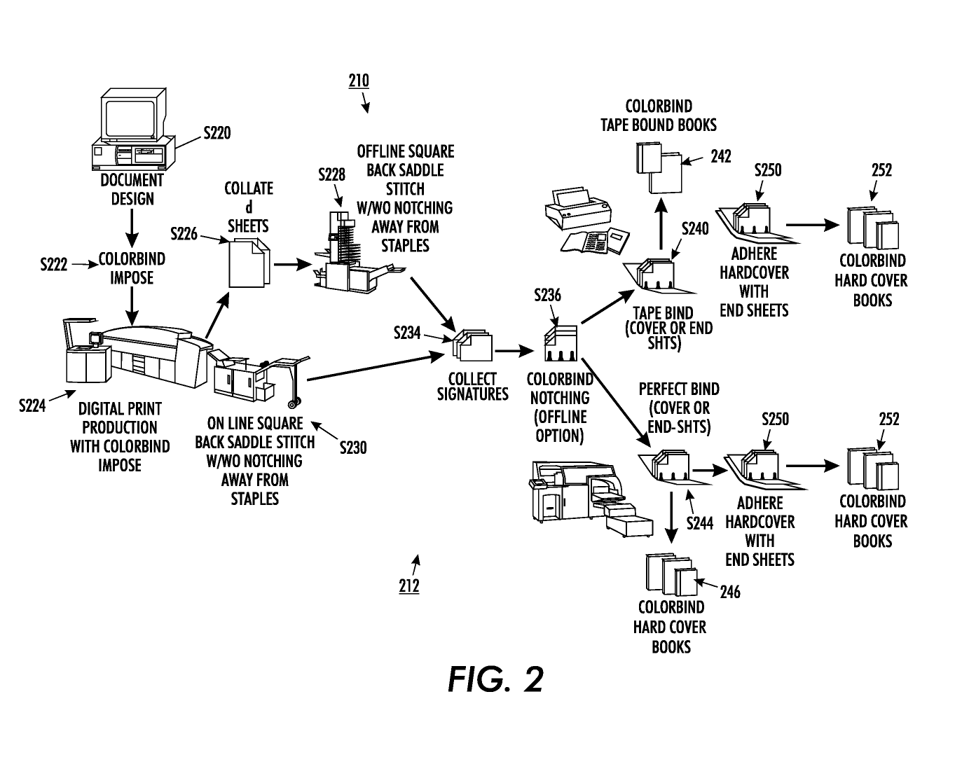

Referring generally to FIG. 2, it will be appreciated that in order to construct a larger book, having multiple saddle-stitched or stapled sets, requires that the page images for printing be organized into sets, and that that the sets be somehow fastened or joined to one another as depicted by the exemplary methods 210 and 212. Depicted in FIG. 2 is a method of creating a bound book. The method, comprises first arranging a plurality of page document images for printing. As it will be understood, in order to create the book a plurality of signature sets must be created, and as will be further recognized, the layout of the sets may be altered; meaning some signature sets or blocks may have more or fewer pages than others. Accordingly, there is a large degree of control over the ordering and “grouping” of pages into respective sets.

This step of ordering and grouping of a document designed at step S220 is reflected in FIG. 2 as DualBind Impose step S222. It should also be understood that in accordance with aspects of the disclosed method, it is possible to employ the impose step to control the location of certain pages images. For example, if the document design of S220 includes a two-page spread photo, the ordering and blocking of the page images may be altered in such a manner as to make sure that the 2-page spread spans the innermost pages of a signature set (110 of FIG. 1), so that while a staple will be present therein, the page will easily open and illustrate the entire image—without a loss of image or discontinuity as may be found in other pages along a binding edge. More specifically, the location of the innermost signature pages may be adjusted within the document, before printing and assembly, in order to assure that critical pages (e.g., two-page spread photo) are printed on the innermost signature page.

It may also be possible for the ordering and blocking step to adjust the page gutters of the digital pages to be printed at S224 to further account for different sized gutters for signature pages in the center of the set versus at the outer-most pages of the set, recognizing that in a signature, square-backed set the gutter may be slightly larger for the outermost pages than it is for the innermost pages. Again such pre=print processing may be advantageous in assuring the continuity and accurate positioning of pages within the set. Printing at S224 is accomplished using any of several well-known digital color printing systems manufactured by companies such as Xerox, Cannon, Hewlett-Packard, Oce and Kodak.

It is a further aspect of the system and method described herein to determine additional workflow elements essential to produce this type of a book product. For example, it is essential that in the digital print process the actual print file is imposed in such a way as to anticipate dividing the entire block into the appropriate number of stapled signatures. Further it is desirable that no toner or other marking materials be deposited in the area adjacent to the square back spine so that the-adhesive from the binding process will meet only with a paper surface, not paper coated with imaging materials such as toner. It is further understood that such instructions or adjustments can be embedded and enabled in the printer software (e.g., pre-print layout options) and activated when this type of binding is indicated.

Once the ordering and grouping of the document pages is completed at S222, both methods continue with printing the page images on a plurality of substrate sheets S224, and arranging said sheets into a plurality of sets of sheets or signature sets or blocks S234. The digital color or black/white printer can deliver the properly imposed and modified 4-up printed sheets directly into an on-line square back booklet maker or the individual printed sheets can be loaded into an offline collating or re-feeding device to provide them to an attached square back booklet maker. A simple code can be imprinted on the sheets to indicate the beginning and end of the signature, or software controlling the feeder or collating device can be implemented to insure creating the signatures in the proper sequence. A further extension of the adhesive bound square-back signature binding process may include a totally in-line system with the signature booklet maker and perfect binding process connected together to deliver final books bound and trimmed as further described below. The process also could be extended to high-volume trade bindery systems for binding conventional lithographically printed multiple-up folded signatures.

In method 210, the signatures are created by first collating the printed sheets, S226, and then using an off-line saddle-stitching machine such as a Watkiss or Plockmatic device to create the square-backed set or block. Alternatively, as depicted in S230, the above-described operations may be accomplished automatically using an on-line system that receives output directly from the printer. As indicated at steps S228 and S230, the sets of sheets are bound with at least one saddle stitch to produce a square-backed bound set. It is also contemplated that the edge of the square-backed bound set is interrupted along at least a portion of the thereof as will be described, for example, in various alternative methods below and as depicted S228/S230 or at S236.

Once the completed sets or blocks are available for an entire book, the alternative methods both contemplate assembling the square-back, bound sets using an adhesive applied to at least a portion of the square-backed edges thereof to produce a bound book. As illustrated in method S210, the process is accomplished as a tape binding step S240 to produce a tape-bound book 242. As illustrated in method S212, the process is accomplished as a perfect binding step S244 to produce a perfect bound book 246. For example, using equipment such as that produced by Borg and others, the binding process applies a glue or other adhesive to the edge of the pages, saturating down onto the page fibers, and then folds and binds a pre-printed cover to the pages. However, the perfect bind system is typically employed to bind cut page edges, where there is some structure (e.g., cut edge) for the glue to adhere to.

In the present system/method, the signature block edges provide a much larger binding surface than cut page edges, and therefore improve the strength of the binding. However, if additional binding strength is required it is considered an option of the various embodiments described herein to further process the outer edges or spines of the square-backed signature sets prior to binding the block of sets. Moreover, the processing may be done in-line or off-line, and may be done to individual signature sets or to the assembled block of sets. The additional process of interrupting the edges or spines may be of particular value, for example, when the pages are printed on coated paper and/or when there is a printing residue both of which may impact adhesion of the binding adhesive (tape or perfect bind) to the square-back signature blocks 110. Although described herein relative to advantages for coated paper stocks, the present invention is believed to find particular use for a range of substrate materials, including but not limited to smooth paper stocks, coated paper stocks, uncoated paper stock, vellum stocks, synthetic stocks including a high-density polyethylene fiber stock such as Tyvek® made by Dupont.

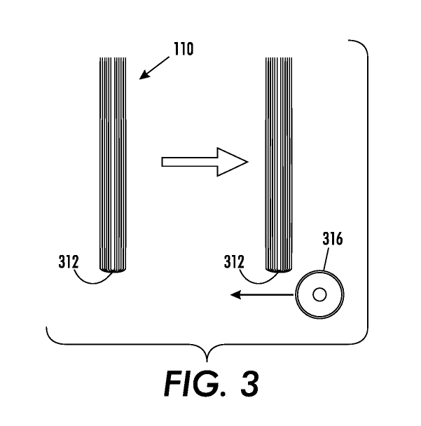

To improve the binding of the square-backed sets, the system and methods S210 and S212 both contemplate, as described above, interrupting at least a portion of the square-backed edge to provide some structure for the adhesive to contact. In one embodiment, depicted in FIG. 3, the interruption of the square-back edge 312 may be accomplished by abrading the portion of the edge (e.g., a portion other than where stapled). In addition to simple abrasion to produce a roughened surface (interrupting the coated surface), it is also possible to cut the portion of the edge other than where the staples are present. FIG. 3 illustrates a circular knife or abrasion device 316 that passes in a direction generally perpendicular to the edge 312 and while passing abrades or notches the edge. It will be appreciated that it may be desirable to make such interruptions at positions other than where staples are present—both to avoid damaging the knives or abrading device, as well as to prevent any weakening of the saddle stitching of the block 110.

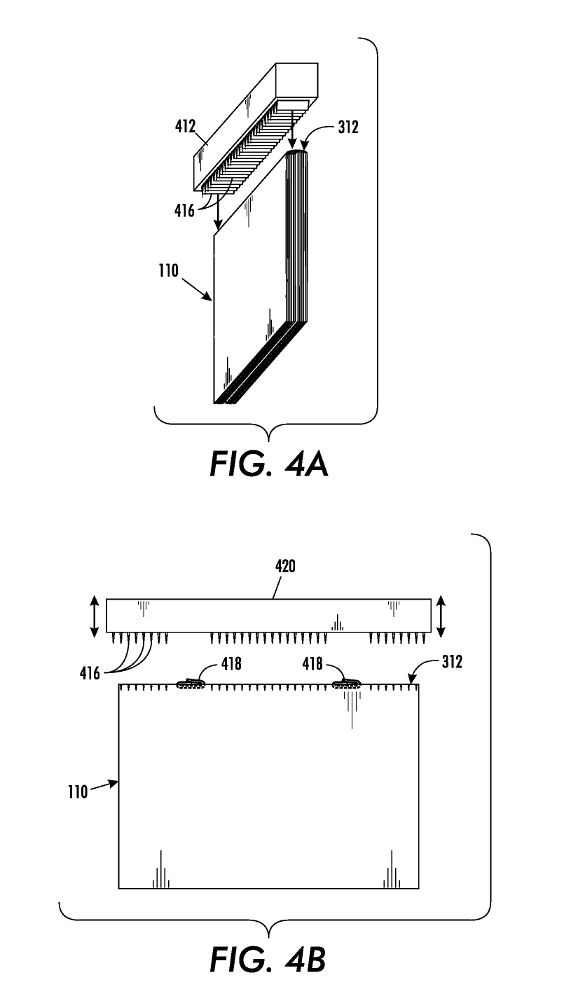

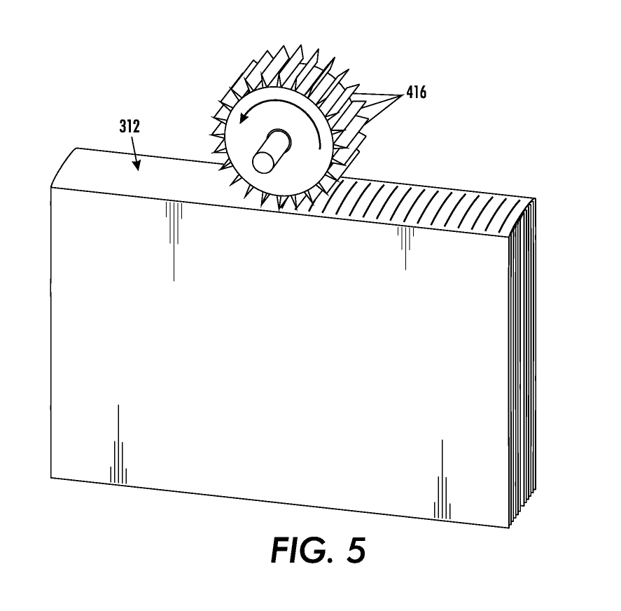

In the alternative embodiment depicted in FIGS. 4A and 4B and 5, the method of interrupting at least a portion of the square-backed edge comprises applying an uneven anvil surface 420 to the portion of the square-backed edge 312 to cause the edge to be permanently deformed by the uneven anvil surface. In one embodiment this method of interrupting the edge may be accomplished by a modification to the square-backed signature block apparatus, wherein the typical face of anvil 412 or 420 (flat (e.g. FIGS. 4A and 4B), round (e.g. FIG. 5), etc.) is modified to include ridges 416. Ridges, 416, which may be sharpened or pointed on the outermost edges or tips, are impressed against the back of the signature block when the squared back is being formed. Hence, in addition to forming the square-back edge, the anvil may be used to deform the edge and impart the additional structure necessary to improve the ability of the edge to be bound using the tape or perfect binding systems. Here again, the addition of structure to the edge is believed to be preferable in regions where staples 418 are not present so as to prevent any interference with the staples or other signature stitching methods.

As described, it may be desirable to create an “interruption” of the spine or outer surface of the folded edge of the square-backed sets by abrasion, cutting notches or impressing grooves generally cross-wise or perpendicular to the length of the spine of each block so that in a subsequent adhesive binding operation the interruptions provide adequate structure to promote the adhesive coupling of each signature to a web and thereby to each other. The number of notches can vary from about 6 to about 30 over the length of the spine. The width and depth of the notches can also vary but typical dimensions would be approximately 0.060 inches wide by 0.060 inches deep. This disclosure suggests that the notches can be fabricated using a number of methods. One embodiment is to incorporate a notching tool directly into the anvil of the square back signature booklet maker. The notches would be directly incorporated into the booklet making process and positioned in such a way as to avoid the position of the mechanical staples holding the signature together. In one embodiment this notching system would be interchangeable with a regular anvil so that the square-back device could still produce square back booklet signatures as a separate product. The second embodiment for producing the interruptions was described as an offline device that abrades a full book block, or multiple blocks, at one time with a properly shaped tool. The notched square back signature can then be bound together in a conventional manual or automatic perfect binding product or by using a tape or other adhesive binder. Because the books are already notched, the abrading and notching system built into a perfect binder system may be disabled.

Returning to FIG. 2, it will be appreciated that in order to make a hardcover book (as opposed to the alternative processes to make softcover or “paperback” books), the methods 210 and 212 may be further extended to include step S250 to affix or adhere the bound book into a hard cover, thereby producing a DualBind hard cover book 252. Hence, attaching a soft cover to the bound signature blocks yields a soft cover book. To fabricate a hardcover book from these multiple square back signatures either the front and back sheets of the bound book block can be used as end sheets to bind into a hardcover system with pre-applied adhesive or before the adhesive binding process as described, for example, relative to FIG. 1. The resultant bound block has improved and more consistent strength over books that are not signature stapled. The square back process also presents a vastly larger surface area to the adhesive binding process improving the signature-to-signature adhesion. Finally books produced in this manner are easier for a reader to use as they lay flat when opened because the square back signature process provides a predetermined hinge point at the square back spine.

A further improvement contemplated in accordance with the present invention suggests that a wraparound cover sheet be bound to the book block in the same way that a printed cover would be bound. This single cover sheet is then glued to the hardcover case in the various methods mentioned above for producing a hardcover book. In a production environment the actual printed cover can be used as the end sheet. This further permits printing and binding a common soft cover book, which can then be converted without modification to a hardcover product. Such a process greatly simplifies set up time, reduces inventory, and enhances the flexibility of producing books on demand

As mentioned above, a further improvement would be to substitute a cover sheet to be bound to the book block with a pressure sensitive adhesive already on the cover sheet. As depicted in FIG. 1, upon removing the adhesive liner 132, the bound book block may be assembled to the hardcover case without the expense of applying a pressure sensitive adhesive and liner to both sides of the hardcover. This technique substantially reduces the time to assemble the book block and the cost of preparing the hardcover case.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of creating a bound book from a plurality of sheets, comprising:
binding at least two sets of sheets from the plurality of sheets, each set being bound with at least one saddle stitch to produce a square-backed bound set; and
assembling the at least two square-backed bound sets using an adhesive applied to at least a portion of the square-backed edges thereof to produce a bound book.

2. The method of claim 1, further comprising:
arranging a plurality of page images for printing to produce the sets of sheets; and
printing the page images on a plurality of substrate sheets, and arranging said sheets into the sets of sheets.

3. The method of claim 1, further comprising interrupting at least a portion of a square-backed edge of each of the sets of sheets.

4. The method of claim 3, wherein interrupting at least a portion of the square-backed edge occurs after the set of sheets has been bound together.

5. The method of claim 1, wherein said saddle stitch is a back saddle stitch.

6. The method of claim 1, wherein said saddle stitch is a front saddle stitch.

7. The method of claim 1, further comprising affixing the bound book into a hard cover.

8. The method of claim 1, wherein assembling square-backed bound sets comprises tape binding the bound sets.

9. The method of claim 3, wherein interrupting at least a portion of the square-backed edge comprises abrading the portion of the edge.

10. The method of claim 3, wherein interrupting at least a portion of the square-backed edge comprises cutting the portion of the edge.

11. The method of claim 3, wherein interrupting at least a portion of the square-backed edge comprises applying an uneven anvil surface to the portion of the square-backed edge, causing the edge to be permanently deformed by the uneven anvil surface.

12. The method of claim 11, where the anvil surface has a plurality of ridges protruding therefrom, each of said ridges, when placed in contact with the square-backed edge, causing a deformation of the edge about the ridge contact area.

13. The method of claim 1, further comprising applying a cover to the bound book.

14. The method of claim 13, wherein applying the cover comprises adhering front and back sheets of the book to a hard cover case.

15. The method of claim 14, wherein front and back sheets of the book have an adhesive pre-applied thereto.

16. The method of claim 1, wherein arranging a plurality of page images for printing comprises determining the location of a two-page spread image and placing the two-page spread image at a center location of one of the square-backed bound sets.

17. The method of claim 1, wherein the substrate is selected from a group of substrates consisting of:
a smooth paper stock;
a coated paper stock;
an uncoated paper stock;
a vellum stock;
a synthetic stock; and
a high-density polyethylene fiber stock.

18. A method for producing a book, comprising:
printing a plurality of signature pages in at least one set of pages, wherein at least one of the outermost page faces of said set includes an adhesive surface thereon; and
exposing said face with adhesive thereon to an interior face of a hard cover block so as to affix the set of pages to the hard cover block.

19. The method of claim 18, wherein the adhesive surface is a pre-applied adhesive for a page that is mechanically attached to other pages in the set of pages.

20. The method of claim 18, wherein the set of pages is bound as a square block signature set.
